(19) United States
(12) Patent Application Publication
(10) Pub. No.: US 2012/0320714 A1
(43) Pub. Date: Dec. 20, 2012

(54) CARD READER

(76) Inventors: Su-Wei Lin, Taipei (TW); Ya-Hui Chang, Taipei (TW)

(21) Appl. No.: 13/524,320

(22) Filed: Jun. 15, 2012

(30) Foreign Application Priority Data
Jun. 17, 2011 (TW) 100210967

(51) Int. Cl. G10K 11/00

(52) U.S. Cl. 367/197

(57) ABSTRACT

A card reader includes a control circuit, an audio transmission interface, and a conversion circuit. The control circuit is utilized to control data access of a smart card so as to read a first digital data from the smart card and write a second digital data to the smart card. The audio transmission interface is utilized to output a first analog audio signal and to receive a second analog audio signal. The conversion circuit is coupled to the control circuit and the audio transmission interface so as to convert the first digital data into the first analog audio signal and to convert the second analog audio signal into the second digital data.

### BACKGROUND OF THE INVENTION

1. Field of the Invention

The present disclosure relates to a card reader, and particularly, a card reader utilizing an audio transmission interface to communicate with a portable electronic device.

2. Description of the Related Art

A smart card, or so-called chip card, generally refers to a mobile plastic card attached or embedded with an integrated circuit chip, such as a telephone integrated circuit (IC) card, personal identification IC card, IC financial card, or credit card. Microprocessors and memories are included in these cards, in which the microprocessors are utilized to perform logical algorithms and process the data and the memories are utilized to store information relating to a card owner, such as personal data, trade records, and bank transaction identification codes.

In use, the smart card is inserted into a card reader, which is electrically connected to a computer, so that, with connections to the Internet and a remote server, a user can perform various operations, such as bank transfers, shopping, filing of tax returns, etc.

That is, the smart card can be utilized to perform the above-described various operations only when the smart card is connected with the Internet and the remote server via facilities such as Internet-capable computers and networks, generally located at home, in the office, or in domestic areas. However, for people who are often out on business trips or are otherwise travelling and are away from such facilities, or for people who are involved in outdoor activities, for example, it can be relatively inconvenient to use smart cards.

### BRIEF SUMMARY OF THE INVENTION

In view of the foregoing, the present disclosure provides a card reader with Internet connection capabilities, and operable to be connected to a portable electronic device, such that a smart card can be utilized normally through the card reader, even in outdoor areas or areas otherwise away from traditional smart card facilities, thereby promoting convenience and mobility. The present disclosure further provides a card reader that is connected to a portable electronic device via an audio transmission interface and is capable of cooperating with merchant portable electronic devices that are equipped with audio transmission interfaces.

The present disclosure, in one embodiment, particularly provides a card reader comprising a control circuit, an audio transmission interface, and a conversion circuit. The control circuit is utilized to control data access of a smart card so as to read a first digital data from the smart card and write a second digital data to the smart card. The audio transmission interface is utilized to output a first analog audio signal and to receive a second analog audio signal. The conversion circuit is coupled to the control circuit and the audio transmission interface so as to convert the first digital data into the first analog audio signal and to convert the second analog audio signal into the second digital data. The conversion circuit can comprise an encoder, a digital-to-analog converter, an analog-to-digital converter, and a decoder, wherein the encoder is utilized to encode the first digital data into a first digital audio signal, the digital-to-analog converter is utilized to convert the first digital audio signal into the first analog audio signal, the analog-to-digital converter is utilized to convert the second analog audio signal into a second digital audio signal, and the decoder is utilized to decode the second digital audio signal into the second digital data.

A card reader of the present disclosure, in further embodiments, comprises a boost circuit coupled to the control circuit and the conversion circuit so as to provide the control circuit and the conversion circuit with required working voltages. A card reader of the present disclosure may further comprise a battery utilized to provide electric power to the control circuit and the conversion circuit via the boost circuit.

A detailed description is given in the following embodiments with reference to the accompanying drawings.

### BRIEF DESCRIPTION OF THE DRAWINGS

The present invention can be more fully understood by the subsequent detailed description and examples with references made to the accompanying drawings, wherein:

FIG. 1 is a schematic view of a smart card, a portable electronic device, and a card reader of one of embodiments of the present disclosure;

FIG. 2 is a block diagram in accordance with a card reader of the present disclosure;

FIG. 3 is a block diagram in accordance with a conversion circuit of a card reader of the present disclosure;

FIG. 4 is a block diagram of a portable electronic device;

FIG. 5 is a block diagram of a conversion circuit of a portable electronic device; and

FIG. 6 is a schematic view of a smart card, a portable electronic device, and a card reader of another embodiment of the present disclosure.

### DETAILED DESCRIPTION OF THE INVENTION

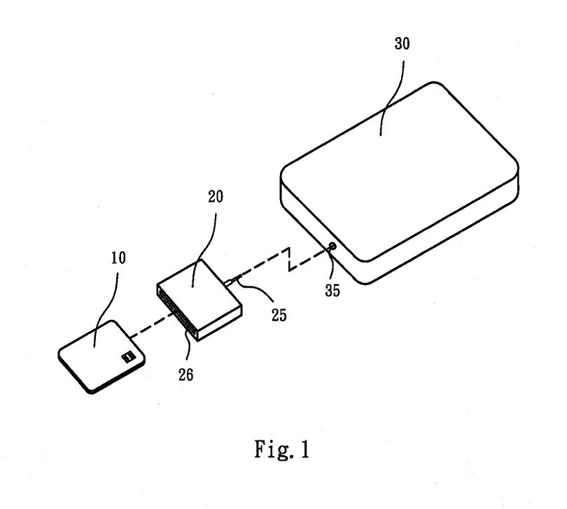

Referring to FIG. 1, a schematic view of a smart card 10, a portable electronic device 30, and a card reader 20 of one of embodiments of the present disclosure is illustrated. In this embodiment, the portable electronic device 30 can be an Internet-capable or Internet-enabled smart phone (e.g., iPhone of Apple Inc. or Smart phone with Android OS), tablet personal computer (PC) (e.g., iPad of Apple Inc.), or a digital multimedia player (e.g., iPod touch of Apple Inc.). With application programs related to the smart card 10 included with, or downloaded to, the portable electronic device 30, data exchanging or processing between the portable electronic device 30 and the smart card 10 can be performed through the card reader 20 of the present disclosure, and operations such as verification, authorization for read access, amendment, and object execution can be performed via communications with a wireless network and a remote server (not shown in Figs.).

The card reader 20 of the present disclosure is configured with an audio transmission interface, and functionally corresponds to those commercially available portable electronic devices equipped with audio transmission interfaces, so that data transmission can be performed between the card reader 20 and portable electronic devices via the audio transmission interfaces connected therewith. In this embodiment, the audio transmission interface of the card reader 20 is an integrated type audio terminal 25, which integrates audio output and input on the same terminal so as to perform audio signal output and input simultaneously. In use, the audio terminal 25 of the card reader 20 is connectively plugged in an audio receptacle 35 of the portable electronic device 30, and the smart card 10 is inserted into a slot 26 of the card reader 20 to communicate with the remote server (not shown) through the Internet-capable portable electronic device 30.

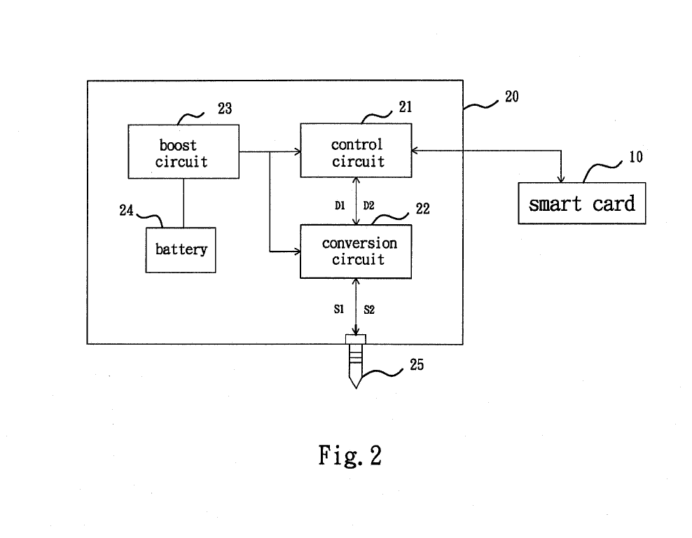

Referring to FIG. 2, a block diagram in accordance with one embodiment of the card reader 20 of the present disclosure is illustrated. In FIG. 2, the card reader 20 comprises a control circuit 21, a conversion circuit 22, a boost circuit 23, a battery 24, and the audio terminal 25. The function of these components will be described in detail hereinafter.

The control circuit 21 is utilized to control data access of the smart card 10. That is, digital data D1 can be read from the smart card 10 and then transmitted to the conversion circuit 22, or digital data D2 of the remote server, received through the conversion circuit 22, can be written to the smart card 10.

The conversion circuit 22, which is coupled to the control circuit 21 and the audio terminal 25, is utilized to convert the digital data D1 into an analog audio signal S1 and output the analog audio signal S1 via the audio terminal 25, or to convert an analog audio signal S2 input to the audio terminal 25 into the digital data D2 and write the digital data D2 to the smart card 10.

The boost circuit 23, which is coupled to the control circuit 21 and the conversion circuit 22, is utilized to provide the control circuit 21 and the conversion circuit 22 with required working voltages. The battery 24 is utilized to provide electric power to the control circuit 21 and the conversion circuit 22 via the boost circuit 23.

The audio terminal 25 of the card reader 20 is utilized to connect to the audio receptacle 35 of the portable electronic device 30, for outputting the analog audio signal S1 to the portable electronic device 30, or receiving the analog audio signal S2 from the portable electronic device 30.

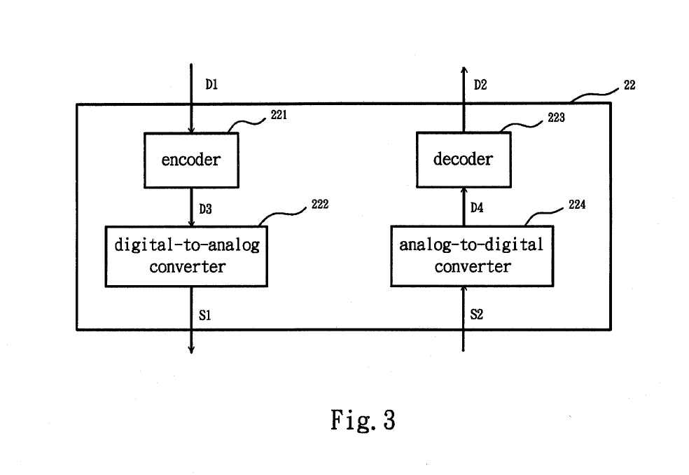

Referring to FIG. 3, a block diagram in accordance with a conversion circuit of a card reader of the present disclosure is illustrated. In FIG. 3, the conversion circuit 22 comprises an encoder 221, a digital-to-analog converter 222, a decoder 223, and an analog-to-digital converter 224. In the conversion circuit 22, the encoder 221 is utilized to encode the digital data D1 into a digital audio signal D3 in a predetermined format, the digital-to-analog converter 222 is utilized to convert the digital audio signal D3 into the analog audio signal S1, the analog-to-digital converter 224 is utilized to convert the analog audio signal S2 into a digital audio signal D4 in a predetermined format, and the decoder 223 is utilized to convert the digital audio signal D4 into the digital data D2.

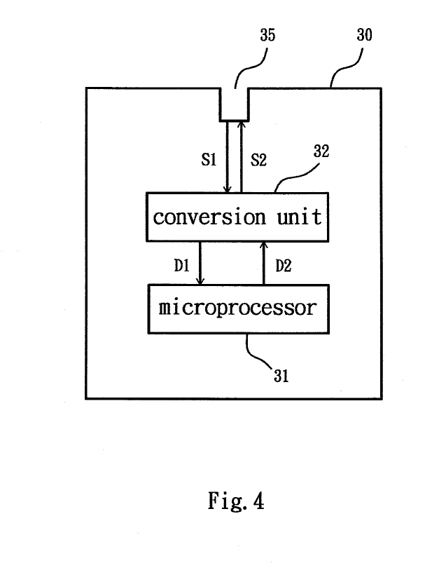

Referring to FIG. 4, a block diagram of the portable electronic device 30 is illustrated, wherein, for ease of illustration, only major components of the card reader 20 related to the present disclosure are shown. However, it is understood that, besides the shown components, the portable electronic device 30 may further comprise a display screen, a driving circuit for the display screen, memories, an antenna, wireless communication circuits, and other related components.

As shown, the portable electronic device 30 comprises a microprocessor 31, a conversion unit 32, and the audio receptacle 35. The function of the components of the portable electronic device 30 will be described in detail hereinafter.

The audio receptacle 35 is utilized to connect to the audio terminal 25 of the card reader 20 to receive the analog audio signal S1 from the card reader 20 or output the analog audio signal S2 to the card reader 20. The conversion unit 32, which is coupled to the audio receptacle 35 and the microprocessor 31, is utilized to restore the analog audio signal S1 input at the audio receptacle 35 to the digital data D1 as read from the smart card 10, or to convert the digital data D2 transmitted from the remote server into the analog audio signal S2 and output the analog audio signal S2 via the audio receptacle 35. The microprocessor 31 is utilized to process the majority of data of the portable electronic device 30 and user input operation instructions, including the digital data D1 transmitted from the smart card 10, the digital data D2 transmitted from the remote server, the processing operations for showing the digital data D1 and D2 on the display screen, and the processing operations for executing the instructions of the user.

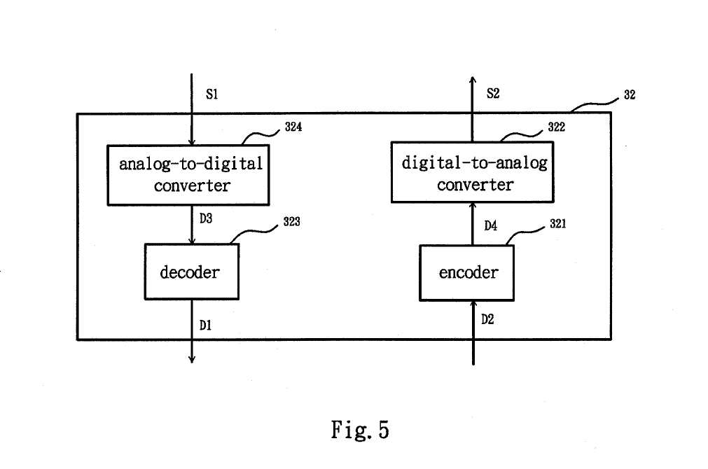

Referring to FIG. 5, a block diagram of a conversion circuit of the portable electronic device 30 is illustrated. In FIG. 5, the conversion unit 32 comprises an encoder 321, a digital-to-analog converter 322, a decoder 323, and an analog-to-digital converter 324. The analog-to-digital converter 324 is utilized to convert the analog audio signal S1 into the digital audio signal D3 in a predetermined format and transmit the digital audio signal D3 to the decoder 323. The decoder 323 decodes the digital audio signal D3 into the digital data D1 as read from the smart card 10. The encoder 321 receives the digital data D2 transmitted from the remote server via the microprocessor 31 and encodes the digital data D2 into the digital audio signal D4 in a predetermined format. The digital-to-analog converter 322 converts the digital audio signal D4 into the analog audio signal S2 and then transmits the analog audio signal S2 to the audio receptacle 35.

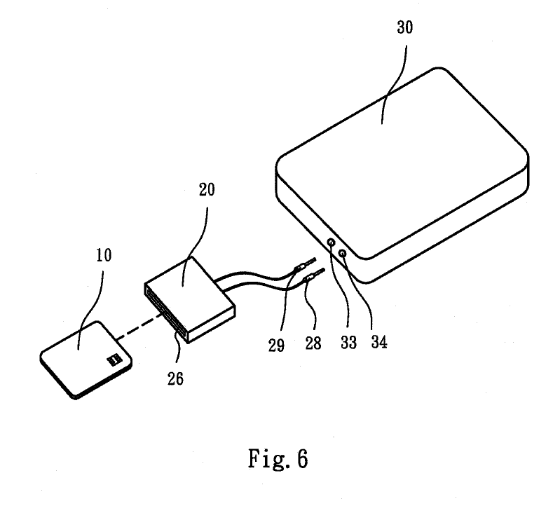

Referring to FIG. 6, a schematic view of a smart card, a portable electronic device, and a card reader of another embodiment of the present disclosure is illustrated. In this embodiment, the audio transmission interface of the card reader 20 comprises an audio output terminal 28 and an audio input terminal 29, in which the audio output terminal 28 and the audio input terminal 29 are connectively plugged in a microphone receptacle 34 and an earphone receptacle 33 of the portable electronic device 30 respectively, so as to transmit the input and output audio signals individually. Note that the other components and related functions of the card reader 20 are identical or substantially identical to those of the previous embodiment. Thus, the descriptions thereof are omitted.

In conclusion, with the card reader of the present disclosure providing Internet connection capabilities when operably connected to a portable electronic device, a smart card can be utilized normally through the card reader, even in outdoor areas or areas otherwise away from traditional smart card facilities, thereby promoting convenience and mobility. Additionally, the card reader of the present disclosure utilizes the audio transmission interface to transmit the data, so that the card reader can cooperate with those merchant portable electronic devices equipped with the audio transmission interface.

Although, in the above-described embodiments, the card readers of the invention are illustrated by cooperating with the portable electronic devices, it is appreciated that the card reader of the present disclosure can still be connectively cooperated with desktop computers in domestic areas, i.e., the actual application of the card reader of the present disclosure is not limited to either indoor or outdoor areas.

While the invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A card reader, comprising:
a control circuit controlling data access of a smart card so as to read a first digital data from the smart card and write a second digital data to the smart card;
an audio transmission interface outputting a first analog audio signal and receiving a second analog audio signal; and
a conversion circuit coupled to the control circuit and the audio transmission interface so as to convert the first digital data into the first analog audio signal and to convert the second analog audio signal into the second digital data.

2. The card reader as claimed in claim 1, wherein the conversion circuit comprises an encoder, a digital-to-analog converter, an analog-to-digital converter, and a decoder, wherein the encoder encodes the first digital data into a first digital audio signal, the digital-to-analog converter converts the first digital audio signal into the first analog audio signal, the analog-to-digital converter converts the second analog audio signal into a second digital audio signal, and the decoder decodes the second digital audio signal into the second digital data.

3. The card reader as claimed in claim 1, further comprising a boost circuit coupled to the control circuit and the conversion circuit so as to provide the control circuit and the conversion circuit with required working voltages.

4. The card reader as claimed in claim 3, further comprising a battery which provides electric power to the control circuit and the conversion circuit via the boost circuit.
